(19) United States
(12) Patent Application Publication
(10) Pub. No.: US 2026/0338417 A1
(43) Pub. Date: Oct. 29, 2026

(54) Heat Storage and Compact Solar Heating System

(71) Applicant: MORGAN STATE UNIVERSITY, Baltimore, MD (US)

(72) Inventors: Seong Lee, Ellicott City, MD (US); Yulai Yang, Towson, MD (US); Quejun Qian, Fitchburg, WI (US); Mohammed M. Haruna, Baltimore, MD (US)

(21) Appl. No.: 19/659,460

(22) Filed: Apr. 27, 2026

Related U.S. Application Data
(60) Provisional application No. 63/794,730, filed on Apr. 25, 2025.
(60) Provisional application No. 63/794,744, filed on Apr. 25, 2025.
(60) Provisional application No. 63/794,756, filed on Apr. 25, 2025.

(51) Int. Cl. F24S 10/30; F24S 20/40; F24S 60/30

(52) U.S. Cl. CPC F24S 10/30; F24S 20/40; F24S 60/30

(57) ABSTRACT

A solar heat generator (SHG) system and method are disclosed that integrate an air heating unit (AHU) and a phase change material (PCM)-based heat storage unit (HSU) to deliver continuous solar-derived space heating during both active solar collection periods and non-collection periods, including nighttime hours. The AHU comprises an insulated enclosure with a bottom absorber plate, a tempered glass glazing layer, and a cross-flow air inlet manifold. The HSU includes a plurality of copper pipes enclosing a paraffin wax PCM, with black-painted copper mesh loosely packed between each adjacent pipe as baffles. During daytime hours, sunlight warms the air passing through the AHU and melts the PCM in the HSU. During nighttime hours, the PCM solidifies, giving up its heat to the air passing through the AHU, allowing heating of the air long after sundown.

### FIELD OF THE INVENTION

This invention relates to air-based solar thermal energy collection and storage systems.

### BACKGROUND OF THE INVENTION

In 2014, approximately 8.4% of households were living in mobile homes, and high space heating cost is a continuing economic challenge across low-income and middle-class sectors. Electric space heating is the primary supplemental heating source in most mobile and tiny homes. Electric heating in these settings presents multiple challenges including fire hazards, the generation of dry heat, high daily operating costs of approximately $3.78/day based on a cost of $0.105/kWh, and the environmental consequences of fossil fuel combustion.

Solar heaters represent a class of renewable thermal energy devices with established applications in space heating, ventilation, and agricultural drying. Flat plate solar collectors are well-established thermal energy devices that convert incoming solar radiation into usable heat by directing solar energy onto an absorber surface and transferring the resulting thermal energy to a working fluid-commonly air or liquid—for delivery to a conditioned space. Air-based designs are valued for their low mass, absence of liquid-related failure modes such as corrosion, freezing, and boiling, and compatibility with integration into building structures and envelopes. Prior solar collector systems have lacked efficient mechanisms for storing and deploying thermal energy beyond active collection periods.

### SUMMARY OF THE INVENTION

The principal disadvantage of air-based solar collectors is the low heat storage capacity of air, which makes it difficult to regulate temperature and deliver heat during nighttime hours; however, the introduction of a heat storage tank incorporating Phase change materials (PCM) material can overcome this principal weakness.

The present disclosure describes a Solar Heat Generator (SHG) that integrates an Air Heating Unit (AHU)—an insulated enclosure topped with a transparent glazing layer, a dark-colored radiation-absorbing plate, and internal channels through which air is circulated before being delivered to a conditioned space—with a Heat Storage Unit (HSU) made of plurality of heat-conducting pipes or tubes placed in the insulated enclosure of the AHU, where the pipes are filled with a phase change material, the channels or spaces between the pipes contain loosely packed black-painted copper mesh baffles. Optional enhancements include a twisted tube heat exchanger, a closed-loop feedback control system, and high-efficiency reflective materials including polished anodized aluminum and Mylar®.

It is specifically noted that every combination and sub-combination of the above-listed and below-described features and embodiments is considered to be part of the invention.

### BRIEF DESCRIPTION OF DRAWINGS

The foregoing summary, as well as the following detailed description of the preferred invention, will be better understood when read in conjunction with the appended drawings. For the purposes of illustrating the invention, there are shown in the drawings embodiments which are presently preferred. It should be understood, however, that the invention is not limited to the precise arrangements and instrumentalities shown. In the drawings:

FIG. 1 is an overhead perspective view of an SHG according to an embodiment of the invention with the solar collecting glazing removed from the top of the AHU and showing the elements of the HSU.

FIG. 2 is a perspective cutaway sketch of an SHG situated outdoors and connected by air tubing to an indoor space and showing the arrangement of the PCM containing-tubes and the L-shaped cross-flow air distribution manifold according to an embodiment of the invention.

FIG. 3 shows a test configuration of a prototype embodiment of the invention.

FIG. 4 is a chart showing the performance of a prototype of an embodiment of the invention.

### DETAILED DESCRIPTION OF THE INVENTION

### System Overview

The Solar Heat Generator (SHG) of the invention integrates two components—an Air Heating Unit (AHU) and a Heat Storage Unit (HSU)—into a single system. The AHU serves as the solar energy collection subsystem, and the HSU provides thermal energy storage and timed release. The two subsystems are fluidly connected such that air circulated through the AHU passes across the HSU, enabling thermal charging of the phase change material during solar collection periods and thermal discharging to the conditioned space during non-collection periods.

### Air Heating Unit (AHU)

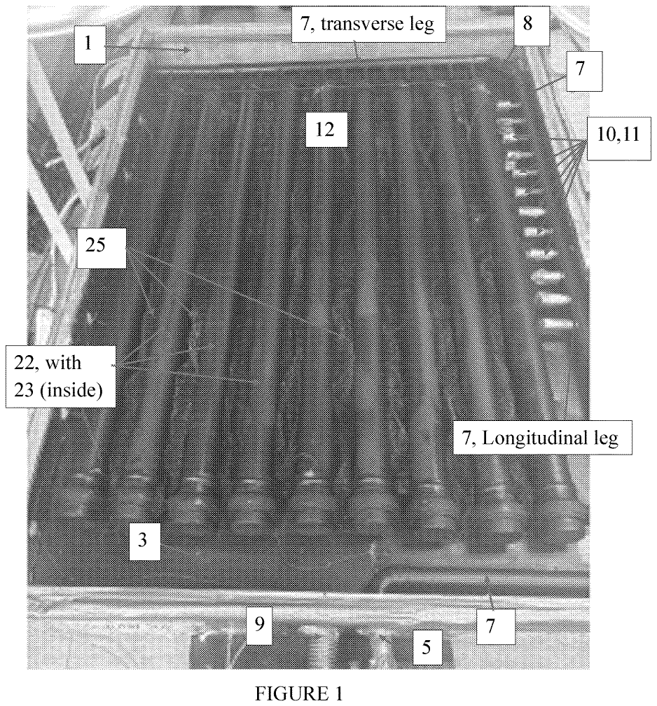

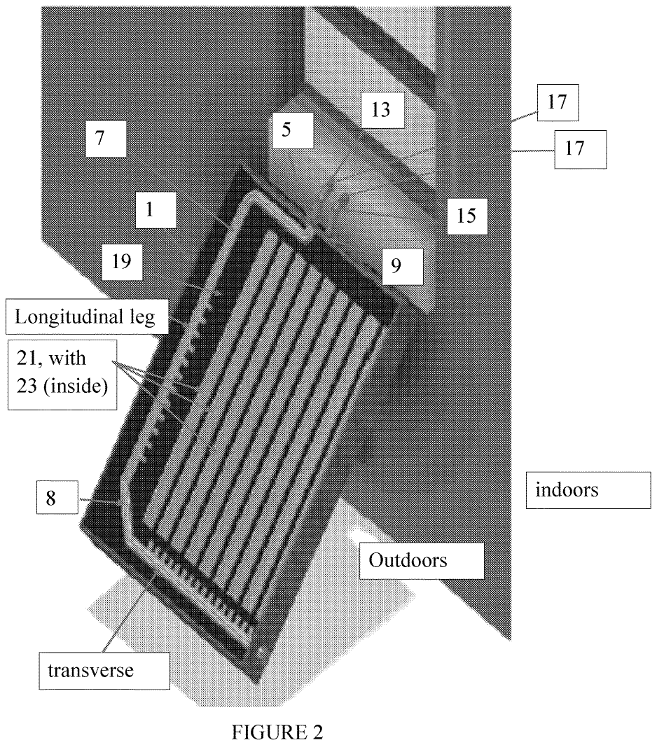

With reference to FIGS. 1-3, the AHU is an insulated enclosure 1 covered with a solar collecting glazing material 3 with air inlet 5, an L-shaped “cross-flow” air distribution manifold 7, and air outlet 9. The L-shaped air distribution manifold 7 has a longitudinal leg having manifold orifices 10 preferably fitted with adjustable nozzles 11 to permit adjustments in the air flow through and across the insulated enclosure. The L-shaped air distribution manifold 7 also has a transverse leg having orifices 12 (shown without optional nozzles 11). The longitudinal leg and the transverse leg of manifold 7 are connected by elbow 8. The air inlet 5 and air outlet 9 are connected by respective tubes 13, 15 to the indoors. Fans 17 are situated inside of, or at the indoor ends of, the air inlet tube 13 and air outlet tube 15 to force ambient indoor air into the AHU and to draw warm air through and out of the AHU and into the indoor space. The inside bottom surface of the insulated enclosure is fitted with an absorbing plate 19, typically in the form of a thin metal sheet. The materials that form the insulated enclosure are either selected or painted to have a dark color, preferably black.

### Heat Storage Unit (HSU)

The HSU rests inside the insulated enclosure 1 and includes a set of sealed heat-conducting pipes 21 filled with a phase change material 23. Phase change materials (PCMs) are substances that store and release thermal energy through the latent heat associated with a solid-to-liquid or liquid-to-solid phase transition. Various PCMs include organic (paraffin compounds and non-paraffin organics), inorganic (salt hydrates and metallics), and eutectic mixtures. Organic, paraffin-based PCMs are preferred for their ability to melt congruently, self-nucleating properties, and compatibility with conventional construction materials.

The spaces between the sealed PCM-containing heat conducting pipes are loosely packed with a heat conducting metal mesh matrix 25.

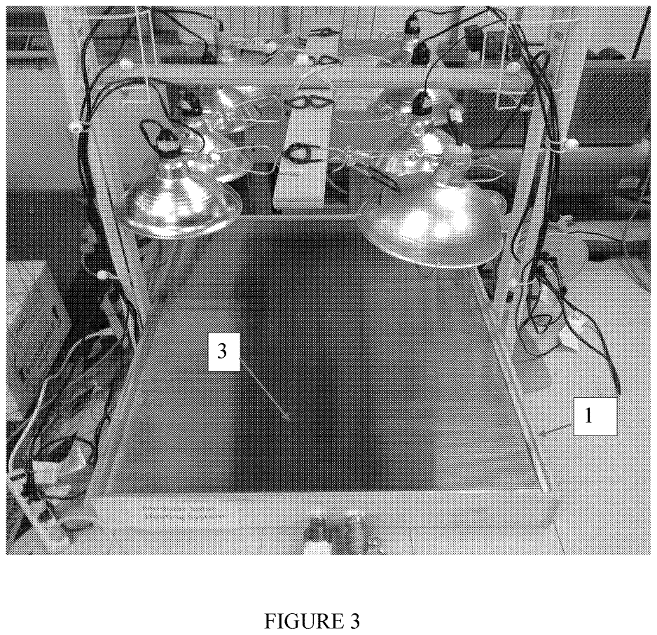

In operation, the SHG of the invention is placed outside in direct sunlight, see FIG. 3. The inlet and outlet fans, preferably placed indoors, move air from the indoor space out into and through the AHU and across the HSU. Heat from the sun causes the temperature inside the AHU to rise, warming the air that is passing through the SHG, but also eventually causing the PCM in the sealed tubes of the HSU to melt, absorbing the energy of the sun and effectively storing it for later. When the AHU is no longer exposed to the sun, liquid PCM of the HSU starts to cool, releasing its energy to the air passing through the AHU and across the HSU so that the air that is passing through the SHG is still being heated even after it is no longer being exposed to the sun. In this way, the SHG of the invention can provide continuous supply of warmed air day and night, provided the sun shines brightly during the day. Based on field testing in winter conditions, the absorber surface temperature can reach 100 °F.

### Example 1

The following is a non-limiting illustrative of an exemplary AHU prototype according to an embodiment of the invention which was built to demonstrate and test the principles underlying the invention. Plywood of ½-inch thickness was cut to required dimensions and assembled as the frame (48″×36″×5″, LWH). Double bubble reflective foil insulation thermal barrier was adhered to the inner and outer surface of the frame. Black 15-gauge aluminum flashing roll was cut to the required dimension and fixed onto the bottom of the frame surface above the insulation layer as the absorbing plate. All components in the solar air heating chamber were painted black to absorb solar energy. Tempered glass was selected as the solar collector glazing material. The air distribution manifold was formed by joining two 1-inch copper radiant manifolds at 90 degrees to one-another using two 45-degree one inch copper fittings. The air distribution manifold was fixed to the inside of insulated enclosure and connected to a 1-inch copper inlet pipe. A 1-inch inner diameter vinyl tube was used to connect the air input and output. Two 3-inch duct fans were attached to the ends of the vinyl tubes to circulate air.

The HSU was made of nine 38×2-inch copper pipes containing paraffin wax as PCM. One end of each pipe was sealed with a solder end cap and the other was closed by a push-fit end cap after filling with paraffin wax. A total of 33 lbs. of wax was encapsulated in the nine pipes. Each pipe was fixed onto the absorber plate of the AHU. Commercial copper mesh material, 5 inches wide and 100 feet long, with a knitted construction, was painted black and filled loosely between each adjacent pipe as baffles to improve outlet temperatures by effective radiative heat transfer. Once the HSU was fully fitted inside the framing of the AHU, the tempered glass glazing material, was placed, completing the assembly and sealing the HSU inside the AHU.

The cross-flow air distribution manifold included twelve nozzles oriented perpendicular to the longitudinal axis of the heat storage copper pipes and fifteen orifices (nozzles optional) oriented on the transverse leg of the manifold and oriented parallel to the longitudinal axis of the heat storage copper pipes. Three nozzle configurations on the longitudinal leg of the manifold were tested: (1) all twelve nozzles fully open (Test #1); (2) all twelve nozzles fully blocked (Test #2); and (3) the six nozzles proximate the air inlet/outlet end blocked, leaving the remaining six nozzles closer to the manifold elbow open (Test #3). In all tests performed, the orifices on the transfer leg of the manifold were left fully open.

The three test configurations were conducted indoors under controlled conditions with a simulated solar light source. Average light intensity was 390 W/m², approximately one-third of outdoor solar light intensity on a sunny day. A HUATO S220-T8 Eight Channel Thermocouple Data Logger and eight High Accuracy K-Type Mini-Connector Thermocouples were used to monitor the temperature profile during testing. The simulated solar light source was turned off after six hours of system operation, after which the SHG continued delivering stored heat to the indoor environment.

The quantitative test results are summarized in Table 1:

| | | | | | | Energy | Energy |
|---|---|---|---|---|---|---|---|
| | | | Fan | | Max | Before | After |
| Test | Nozzle | Ambient | Speed | Duration | Power | Light-Off | Light-Off |
| # | Configuration | Temp (°F) | (ft/min) | (min) | (Btu/hr) | (Btu) | (Btu) |
| Test | Fully open | 68 | 1,163 | 720 | 3,082 | 13,389 | 7,402 |
| #1 | | | | | | | |
| Test | Fully blocked | 68 | 1,163 | 736 | 3,427 | 14,914 | 7,763 |
| #2 | | | | | | | |
| Test | Half-open (6 near | 68 | 1,105 | 1,164 | 3,498 | 16,522 | 9,598 |
| #3 | inlet/outlet end | | | | | | |
| | blocked) | | | | | | |

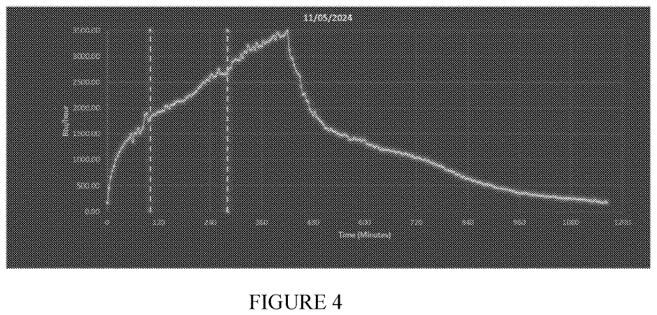

Test results confirmed that fully open nozzles reduce system performance, likely because inlet air is exhausted immediately through nozzles proximate the air outlet. The best performance was achieved in Test #3 (half-open configuration), in which the phase change process was clearly observable in the output chart (FIG. 4) between two dashed lines, and the SHG continued supplying heat for 20 hours after light-off—confirming suitability for actual residential heating needs. Further tests demonstrated that leaving open only the three nozzles 11 closest to the manifold elbow on the longitudinal leg of the manifold and closing the remaining nine nozzles 11 on the longitudinal leg of the manifold performed at least as well as leaving half of the nozzles open and half of them closed. It will be understood that the same or better performance may be achieved by dispensing entirely with orifices and nozzles on the end of the manifold closest to the air inlet, introducing cross-flow air only from the last half to last third of the longitudinal leg of the air distribution manifold.

Notwithstanding the specific embodiments, features, elements, combinations and sub-combinations disclosed herein, it is expressly considered and here disclosed that every single element, every single feature, and every combination and sub-combination thereof disclosed herein may be combined with every other element, feature, combination and sub-combination disclosed herein.

It will be appreciated by those skilled in the art that changes could be made to the embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A solar heat generator system, comprising: an air heating unit comprising an insulated frame, a glazing material positioned over the insulated frame to define an enclosed solar collection chamber, a solar-absorbing plate disposed within the solar collection chamber, and a cross-flow air inlet manifold fluidly connected to the solar collection chamber; and a heat storage unit comprising a plurality of elongated containers each containing a phase change material, and a mesh matrix disposed between adjacent elongated containers; wherein the cross-flow air inlet manifold is configured to introduce airflow into the heat storage unit in at least two directions perpendicular to one another relative to a longitudinal axis of the elongated containers.

2. The solar heat generator system of claim 1, wherein the solar-absorbing plate comprises black-coated aluminum flashing, and the glazing material comprises tempered glass.

3. The solar heat generator system of claim 1, wherein the cross-flow air inlet manifold comprises an L-shape whereby airflow is introduced into the heat storage unit both parallel to and perpendicular to the longitudinal axis of the elongated containers.

4. The solar heat generator system of claim 1, wherein the cross-flow air inlet manifold comprises twelve nozzles oriented perpendicular to the longitudinal axis of the elongated containers.

5. The solar heat generator system of claim 1, wherein a first subset of six nozzles proximate an air inlet end of the heat storage unit are configured in an open position and a second subset of six nozzles proximate an air outlet end of the heat storage unit are configured in a blocked position, whereby air entering the manifold is directed through substantially the full longitudinal extent of the heat storage unit before exhausting, increasing residence time of airflow in contact with the phase change material.

6. The solar heat generator system of claim 1, which yields under indoor test conditions at a simulated solar irradiance of approximately 390 W/m², a maximum heating output of at least 3,498 Btu/hour, a total energy delivery before light-off of at least 16,522 Btu, and continued post-solar heat delivery of at least 9,598 Btu over approximately 20 hours following cessation of solar input.

7. The solar heat generator system of claim 1, wherein the plurality of elongated containers comprise copper pipes.

8. The solar heat generator system of claim 1, wherein the phase change material is paraffin wax.

9. The solar heat generator system of claim 1, wherein the mesh matrix comprises black-painted copper mesh material filled loosely between each adjacent elongated container.

10. A method of collecting and storing solar thermal energy, comprising: absorbing solar radiation using a solar-absorbing plate disposed within an insulated, glazed solar collection chamber of an air heating unit; introducing airflow into a heat storage unit via a cross-flow air inlet manifold configured to direct airflow simultaneously in a first direction parallel to and a second direction perpendicular to a longitudinal axis of a plurality of elongated containers enclosing a phase change material during a solar collection period, thereby transferring thermal energy to the phase change material through a solid-to-liquid phase transition; and continuing to circulate air through the heat storage unit during a non-collection period to extract stored thermal energy from the phase change material as the phase change material transitions from liquid to solid, whereby heat is delivered to a conditioned space in the absence of contemporaneous solar irradiance.

11. The method of claim 10, wherein introducing airflow through the cross-flow air inlet manifold comprises blocking six nozzles of the manifold proximate an air outlet end of the heat storage unit while maintaining six nozzles proximate an air inlet end in an open position, whereby air traverses substantially the full longitudinal length of the heat storage unit prior to exhaust, increasing thermal contact time and enabling continued heat delivery for at least 20 hours following cessation of solar input.
